(19) United States
(12) Patent Application Publication
(10) Pub. No.: US 2019/0063503 A1
(43) Pub. Date: Feb. 28, 2019

(54) METHOD AND APPARATUS FOR MONITORING A SLIDING BEARING

(71) Applicant: Rolls-Royce Deutschland Ltd & Co KG, Blankenfelde-Mahlow (DE)

(72) Inventors: Sebastian NOWOISKY, Michendorf (DE); Noushin MOKHTARI MOLK ABADI, Berlin (DE)

(21) Appl. No.: 16/106,557

(22) Filed: Aug. 21, 2018

(30) Foreign Application Priority Data
Aug. 25, 2017 (DE) 10 2017 119 543.2

(51) Int. Cl. F16C 41/00; F16C 17/02; G01M 13/04; G01D 5/245

(52) U.S. Cl. CPC F16C 41/007; F16C 17/02; F16C 2233/00; G01D 5/2451; G01M 13/045

(57) ABSTRACT

A method for monitoring a sliding bearing, having a shaft mounted therein, in particular a shaft rotating therein, for at least one mixed friction event, wherein at least one time-dependent structure-borne sound signal from at least one structure-borne sound sensor, is recorded from the sliding bearing. The method includes the steps: filtering of the structure-borne sound signal, subsequent calculation of an envelope curve for the filtered structure-borne sound signal, subsequent smoothing of the envelope curve, combination of the data for the smoothed envelope curve with a rotational angle signal which is dependent on the revolution of the shaft in the sliding bearing, and calculation of the maxima, which are correlated with the mixed friction events, from the combined data from step d) for the purpose of determining an angle specification for the at least one mixed friction event on the circumference of the sliding bearing.

### REFERENCE TO RELATED APPLICATION

This application claims priority to German Patent Application No. 10 2017 119 543.2, the entirety of which is incorporated by reference herein.

### BACKGROUND

The invention relates to a method for monitoring a sliding bearing and to an apparatus for monitoring a sliding bearing.

Sliding bearings are a machine element which can be used in a versatile manner and in which the relative movement between a shaft and the bearing shell of the sliding bearing or an intermediate medium is a sliding movement.

A field of application for sliding bearings is, for example, the mounting of planetary gears in planetary transmissions which are used or are intended to be used in turbofan aircraft engines.

The requirements imposed on new engines with regard to fuel consumption, CO₂ emission and sound emission are increasing continuously, with the result that the engine components must constantly be developed further. In future turbofan engines, the compressor and the turbine are intended to be decoupled from the fan for this purpose by using a high-performance planetary transmission. As a result, these components can be operated at their respective optimum operating points. The lower speed of the fan which is thus possible allows the fan diameter to be increased, which results in a higher bypass mass flow without producing supersonics at the fan tips.

Planetary transmissions, the components of which constitute potential wearing parts, for example gear wheels, shafts and bearings, are used in high-performance transmissions. Failure of these components may have serious effects on the overall aircraft engine. In this case, mixed friction events in sliding bearings play a major role since they indicate that the lubrication has been removed from the desired fluid friction region.

### SUMMARY

For this reason, methods and apparatuses are needed to monitor the operation of sliding bearings.

This aspect is addressed by means of a method having features as described herein.

In this case, a sliding bearing, having a shaft mounted therein, in particular a shaft rotating therein, is monitored for at least one mixed friction event. The at least one mixed friction result can be monitored when the sliding bearing is rotating and the shaft is stationary or when the shaft is rotating and the sliding bearing is stationary.

At least one time-dependent structure-borne sound signal (also known as acoustic emission signal) from the at least one structure-borne sound sensor, in particular precisely one structure-borne sound sensor, is recorded. The method can also be carried out, in particular, with only one structure-borne sound sensor, with the result that a particularly economic sensor system is possible.

The time-dependent structure-borne sound signal is first of all filtered in order to suppress other mechanical vibrations, in particular. The structure-borne sound signal has amplitude modulation in the case of mixed friction events.

An envelope curve for the filtered structure-borne sound signal is then calculated, wherein the envelope curves envelope the amplitude-modulated signal in the case of mixed friction events.

The envelope curve generally also has sharp contours, for example prongs, with the result that it is difficult to determine the maxima in the envelope curve which indicate the mixed friction events. The envelope curve is therefore subjected to smoothing.

The data for the smoothed envelope curve are combined with a rotational angle signal which is dependent on the revolution of the shaft in the sliding bearing. The combination is also referred to as merging of the data.

The periodicity of the maxima can therefore be identified. The maxima which indicate the mixed friction events occur in a similar form during each revolution of the shaft.

The maxima are then calculated from the combined data from the preceding step for the purpose of determining an angle specification for the mixed friction events on the circumference of the sliding bearing. If only one mixed friction event is present, only one maximum is determined.

Mixed friction events can therefore be assigned in a simple and robust manner to spatially determined points in the sliding bearing. This can supplement time-based maintenance, for example, with state-based maintenance in order to be able to provide enhanced safety for people, the machine and the environment, to extend the machine operating time and to plan maintenance work in an improved manner.

In this case, in one embodiment, the rotational angle signal can be determined and/or generated by an incremental encoder by means of pattern recognition or a reference pulse, in particular a magnetic reference pulse.

The rotational angle signal can be generated in different ways. In one embodiment variant, the rotational angle signal is generated solely by the movement of the shaft and/or of the sliding bearing, in particular by at least one magnetic element of the shaft and/or in the sliding bearing and an accordingly assigned magnetic sensor (for example a coil). This is passive generation of the rotational angle signal solely by the relative movement of the shaft and sliding bearing.

Additionally or alternatively, the rotational angle signal can be actively generated by means of at least one pulse, in particular a zero pulse or a multiplicity of pulses from the incremental encoder. One pulse, for example the zero pulse, is sufficient in principle. If more pulses are used, the accuracy can be increased.

In one embodiment, the structure-borne sound signal can be filtered using a high-pass filter, in particular with a cut-off frequency of between 50 and 300 kHz, in particular between 80 and 150 kHz. The frequencies of mixed friction events differ from other mechanical vibrations in a sliding bearing, with the result that the mixed friction events can be easily filtered from the entire vibration spectrum.

Furthermore, the envelope curve can be calculated by means of a Hilbert transform or by averaging a predetermined set of filtered structure-borne sound data points.

In one embodiment, the envelope curve can be smoothed by means of a smoothing filter, in particular a Savitzky-Golay filter.

In one embodiment, a computer captures and stores the time-dependent data relating to the angle specification, the angle location, the intensity and/or the duration of the at least one mixed friction event on the circumference of the sliding bearing and emits a signal, in particular a warning signal or a repair signal, if a predetermined condition occurs. The computer can detect, for example, when a particular number of mixed friction events per revolution and/or a particular spatial concentration of the mixed friction events has/have started. Depending on the considered system into which the sliding bearing is integrated, it is possible to formulate conditions which are considered to be acceptable or simply no longer acceptable. In the latter case, it is then possible to emit a signal, for example, which indicates possible failure of the sliding bearing.

In one embodiment of the method, the sliding bearing is arranged in a planetary transmission, in particular in a planetary transmission in a vehicle, a wind power plant or an aircraft engine. Planetary transmissions must generally operate without maintenance for relatively long periods, with the result that monitoring is useful, in particular for a possible prediction of damage.

Kinematic movement data and/or structure-borne sound events of the planetary transmission, in particular the movement data and/or structure-borne sound events of the movements of the sun gear, planet holder and/or planetary gears, can also be filtered out. The frequency ranges of these events are often below the frequency range in which mixed friction events occur.

The object is also achieved by means of an apparatus for monitoring a sliding bearing having features as described herein.

In this case, a means is used to filter the structure-borne sound signal for the purpose of separating it from sound events which differ from mixed friction events.

The apparatus also has a means for calculating an envelope curve for the filtered structure-borne sound signal and a means for smoothing the envelope curve.

The apparatus also has a means for combining the data for the smoothed envelope curve with a rotational angle signal which is dependent on the revolution of the shaft in the sliding bearing.

A means is used to calculate at least one maximum from the combined data for the purpose of determining an angle specification for the at least one mixed friction event on the circumference of the sliding bearing.

Such an apparatus which may be in the form of a microprocessor, for example, makes it possible to efficiently monitor a sliding bearing for mixed friction events.

In this case, in one embodiment, the at least one structure-borne sound sensor may be arranged on the end face of a holder of the sliding bearing.

In one possible design of the at least one structure-borne sound sensor, a piezo element is used to record the structure-borne sound.

In order to efficiently capture the structure-borne sound in mixed friction events, the at least one structure-borne sound sensor can be arranged in the immediate vicinity of the circumference of the sliding bearing, in particular in the immediate vicinity of an application of force.

### BRIEF DESCRIPTION OF THE DRAWINGS

The invention is explained in connection with the exemplary embodiments illustrated in the figures.

FIG. 1 shows a schematic structure-borne sound signal in the case of mixed friction between a shaft and a sliding bearing with amplitude modulation.

FIG. 2 shows a schematic illustration of one embodiment for monitoring a sliding bearing with determination of the angular resolution of the structure-borne sound signal.

FIG. 3A shows a front view of one embodiment of a sliding bearing apparatus.

FIG. 3B shows a perspective illustration of the sliding bearing apparatus according to FIG. 3A.

FIG. 3C shows a further perspective illustration of the sliding bearing apparatus according to FIG. 3B;

FIG. 4 shows a schematic illustration of a test set-up for monitoring the sliding bearing.

FIG. 5 shows a structure-borne sound signal and a Z signal from an incremental encoder for a sliding bearing with a speed of 340 rpm in the case of fluid friction.

FIG. 6 shows a structure-borne sound signal measured over two revolutions of a shaft in a sliding bearing having four mixed friction events (rubbing) per revolution.

FIG. 7 shows the structure-borne sound signal according to FIG. 6 for one revolution with an indication of the angles of the mixed friction events (rubbing).

FIG. 8 shows an illustration of the energy of the envelope of the structure-borne sound signal and of the Z signal without smoothing.

FIG. 9 shows an illustration of the energy of the envelope of the structure-borne sound signal and of the Z signal with smoothing.

FIG. 10 shows one embodiment for monitoring a sliding bearing for mixed friction events in a planetary transmission.

FIG. 11 shows another embodiment for monitoring a sliding bearing for mixed friction events in a planetary transmission.

### DETAILED DESCRIPTION

The practice of monitoring hydrodynamic sliding bearings for mixed friction events is described below on the basis of a plurality of exemplary embodiments.

A hydrodynamic sliding bearing 1 in theory has an infinite service life as long as the shaft 6 and the lining of the sliding bearing 1 are separated from one another by means of a supporting lubricant film. As soon as these two components come into contact, mechanical friction (mixed friction) is produced, which ultimately results in damage. As a result, the sliding bearing 1 can lose its functionality since a supporting lubricant film can no longer be formed in the case of increased abrasion or damage.

A known method for monitoring hydrodynamic sliding bearings 1 uses shaft orbit plots (see J. Deckers, “Entwicklung einer Low-Cost Körperschallsensorik zur Überwachung des VerschleifBverhaltens von wälz-oder gleitgelagerten Kreiselpumpen kleiner Leistung” [Development of a low-cost structure-borne sound sensor system for monitoring the wear behaviour of low-power centrifugal pumps mounted using rolling bearings or sliding bearings], dissertation, Gerhard Mercator University Duisburg, Duisburg, 2001).

In this case, two position sensors fitted orthogonally to the sliding bearing 1 capture the shaft orbit inside the sliding bearing. The two phase-shifted position signals captured in this case are represented in so-called orbit plots in a polar coordinate representation. These plots represent the rotational-angle-dependent movement of the mounted shaft 6 transversely with respect to the axial shaft axis.

A so-called key phasor (reference sensor) is used to capture the phase angle.

If the shaft 6 now moves out of the permissible orbit, rubbing (that is to say a mixed friction event) has taken place between the shaft 6 and the lining of the sliding bearing 1. This can be seen in the shaft orbit plot.

This method makes it possible not only to identify a rubbing process but also to determine the intensity and the position of the contact in the circumferential direction of the sliding bearing lining.

The mutual contact of roughness peaks of the two sliding partners in a mixed friction event (rubbing process) causes structure-borne sound at a frequency of up to 2 MHz in the sliding bearing 1. In comparison with other diagnostic methods, the use of structure-borne sound analysis provides advantages with regard to the early detection of damage to the sliding bearing 1 (see M. Fritz, A. Burger and A. Albers, “Schadensfrüherkennung an geschmierten Gleitkontakten mittels Schallemissionsanalyse” [Early detection of damage to lubricated sliding contacts by means of sound emission analysis], Institute of Machine Design and Automotive Engineering, report, University of Karlsruhe, 2001; P. Raharjo, “An Investigation of Surface Vibration, Airborne Sound and Acoustic Emission Characteristics of a Journal Bearing for Early Fault Detection and Diagnosis”, dissertation, University of Huddersfield, May 2013).

The fluid friction which does not influence the service life can be distinguished from the mixed friction and solid friction which reduces the service life by means of suitable signal processing and feature extraction algorithms. However, the algorithms used for diagnosis by means of structure-borne sound assess the friction state only globally and not locally over the circumference of the sliding bearing 1, that is to say there is no angle-resolved determination of the mixed friction events a, b, c, d.

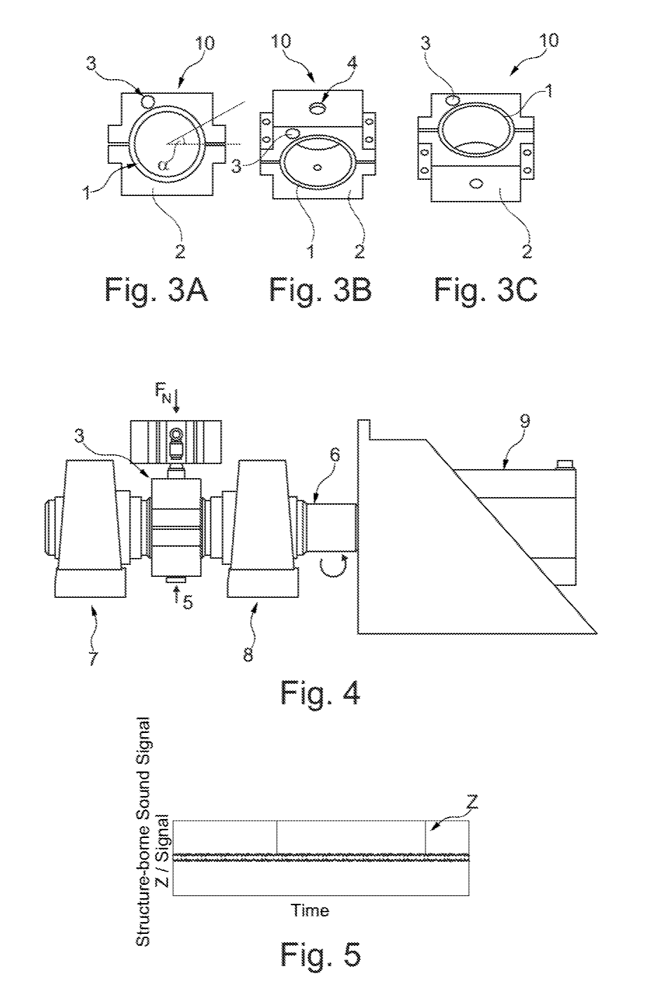

However, knowledge of local mixed friction processes a, b, c, d is essential for predicting the service life of sliding bearings 1. Repeated friction at the position α=20° (for example depicted in FIG. 3A), for example, reduces the service life of the sliding bearing 1 to a greater extent than the same number of friction processes distributed over the circumference.

A phenomenon which occurs when superimposing a high-frequency carrier signal and a low-frequency useful signal is amplitude modulation.

In the event of local contact between the shaft 6 and the lining of the sliding bearing 1, amplitude modulation of the structure-borne sound signal likewise occurs (see M. Leahy, D. Mba, P. Cooper, A. Montgomery and D. Owen, “Experimental investigation into the capabilities of acoustic emission for the detection of shaft-to-seal rubbing in large power generation turbines”, Proceedings of the Institution of Mechanical Engineers, Part J: Journal of Engineering Tribology, vol. 220, no. 7, pp. 607-615, 2006; A. Albers and M. Dickerhof, “Simultaneous Monitoring of Rolling-Element and Journal Bearings Using Analysis of Structure-born Ultrasound Acoustic Emissions”, in International Mechanical Engineering Congress & Exposition, Vancouver, British Columbia, Canada, 2010).

The mixed friction events a, b, c, d occur on the basis of the speed of the shaft 6. The mixed friction events a, b, c, d themselves each generate a structure-borne sound signal which has a considerably higher frequency than the rotational frequency of the shaft 6. Overall, a structure-borne sound signal S in which a low-frequency rotational frequency and a higher-frequency structure-borne sound signal are superimposed is recorded.

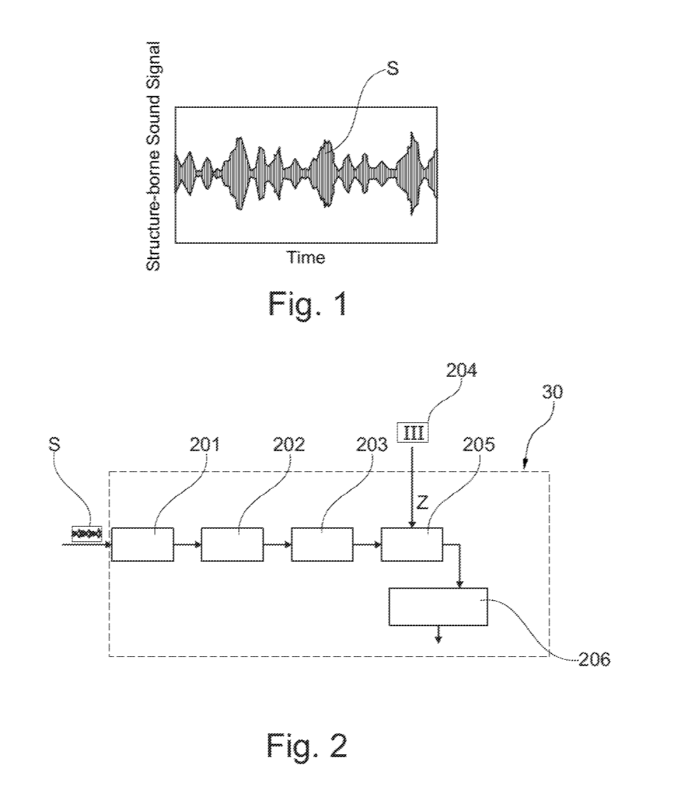

The schematic signal profile of the structure-borne sound signal S can be seen in FIG. 1. The resulting modulations differ in terms of the amplitude and duration.

No amplitude modulations occur in the case of pure fluid friction in which no rubbing processes take place between the shaft 6 and the lining of the sliding bearing 1.

As mentioned above, the exact circumferential position (that is to say the angle α) at which the mixed friction events a, b, c, d occur is an important item of information for predicting the service life. The accumulation of mixed friction events a, b, c, d at a circumferential position can therefore be interpreted as a degree of the wear of the sliding bearing lining.

During appropriate monitoring, the complexity of the measuring chain and the costs of producing a product (here the diagnostic or prediction system) are intended to be kept as low as possible. A reduction in the numbers of sensors, ideally the use of only one sensor, simplifies the measuring chain and also allows a considerable cost reduction.

Embodiments for monitoring sliding bearings 1, which use various properties of the captured structure-borne sound signal S to detect mixed friction events a, b, c, d, are described below.

An envelope curve, also called envelope, envelopes a family of curves (for example that of a structure-borne sound signal S according to FIG. 1). A new curve is therefore produced and makes it possible to make a statement on local maxima and minima of the low-frequency signal modulated onto the high-frequency signal. An envelope curve can be determined, for example, using a Hilbert transform (see D. Guicking, Schwingungen: Theorie und Anwendung in Mechanik, Akustik, Elektrik und Optik [Vibrations: theory and use in mechanics, acoustics, electrics and optics], Gottingen: Springer Vieweg: Springer Fachmedien Wiesbaden, 2016).

However, for the application presented here, it is entirely adequate to know the behaviour of the amplitudes in order to determine the envelope. It is only necessary to detect where local maxima and minima occur. The envelope curve is determined by determining the RMS (root mean square) of a predetermined set of data points. There is therefore also a measure of the energy of the structure-borne sound signal, in which case the peak values and the curve shape are respectively taken into account.

The curve produced from an envelope is provided with curvatures and/or sharp edges which should be smoothed for a statement relating to local maxima and minima. Low-order approximation polynomials, for example, can be used to implement smoothing which is as good as possible for this purpose. One smoothing possibility is the use of the Savitzky-Golay filter (see A. Savitzky and M. J. E. Golay, “Smoothing and Differentiation of Data by Simplified Least Squares Procedures”, Anal. Chem., July 1964).

This method smooths a signal by adapting a polynomial function to the signal piece by piece. This adaptation is carried out using the least squares method between the matrix X and the vector y:

y=Xb

The solution for b with the aid of the least squares is

b=(X^{T}X)⁻¹X^{T}y.

The estimated values \check{Y} used for the smoothing are:

\check{Y}=Xb=X(X^{T}X)⁻¹X^{T}y=Hy

Embodiments of the method for locating mixed friction over the circumference of the sliding bearing lining by means of structure-borne sound measurement are first of all explained in more detail below.

FIG. 2 illustrates execution steps of one embodiment of the method for monitoring a sliding bearing.

In a first step 201, the amplitude-modulated structure-borne sound signal S is subjected to high-pass filtering in order to attenuate, to the greatest possible extent, interference signals from the environment and signals which have nothing to do with the mixed friction events a, b, c, d. In the present case, a cut-off frequency of 100 kHz is used. In other embodiments, other cut-off frequencies can also be used. In general, cut-off frequencies in the range of 50 to 300 kHz are useful since the mixed friction events are mostly above these cut-off frequencies.

In the subsequent step 202, the envelope of the structure-borne sound signal S is formed by means of a Hilbert transform, for example. The method used here forms the average value of a particular number B of signal points n, (for example 800) and stores this value in a vector.

As explained above, the energy of the envelope can be determined using the RMS, but the envelope is provided with sharp curvatures or spikes. In order to be able to determine the local maxima and minima in a numerically clearer manner, a third-order Savitzky-Golay filter, for example, can be used to smooth the structure-borne sound signal S (step 203). In other embodiments, other filters can also be used.

In the embodiment illustrated, an incremental encoder is used to emit pulses to the sliding bearing 1 (step 204). These pulses are rotational angle signals which are dependent on the revolution of the shaft 6 in the sliding bearing 1.

The zero pulse signal (Z signal) from the incremental encoder is used in this application to identify the exact angular position of the mixed friction events a, b, c, d. Precisely one revolution of the shaft 6 in the sliding bearing 1 takes place between two square-wave signals from an incremental encoder. The two signals, both the structure-borne sound signal S and the Z signal Z, are recorded at the same time (step 205). For improved accuracy, more than one pulse signal per revolution can also be used.

If the processed structure-borne sound signal S and the Z signal Z are superimposed (step 205), the maxima—resulting from the structure-borne sound of the mixed friction events—can be accurately assigned to the angular position (step 206).

The signals can be processed and evaluated using a computer 30. The signals from the structure-borne sound sensor 3 can be transmitted to the computer 30 in a conventional manner, possibly via an amplifier. FIG. 2 illustrates that the computer carries out all steps. It is also possible for the computer 30 to operate in a decentralized manner, with the result that individual steps of parts of the computer 30 are carried out by decentralized processors.

In this case, each maximum represents rubbing of the shaft against the sliding bearing lining, that is to say a mixed friction event a, b, c, d. With knowledge of the signal relating to the measured angular positions, each maximum can be assigned an angle which indicates the rubbing point (that is to say the mixed friction event a, b, c, d) in the lining of the sliding bearing

Results in which both mixed friction and—for comparison—fluid friction occurred are described below. Embodiments illustrated in FIGS. 3A, B, C and FIG. 4 were used for this purpose.

A sliding bearing apparatus 10 is illustrated in a front view in FIG. 3A and is respectively illustrated in a perspective view in FIGS. 3B and 3C. In this case, the actual sliding bearing 1 (that is to say the sliding bearing bush) is embedded in a holder 2 which also has the structure-borne sound sensor 3. In the present case, the holder 2, the sliding bearing 1 and the structure-borne sound sensor 3 form a sliding bearing apparatus 10. In other embodiments, the sliding bearing apparatus 10 can also be formed from other components, in particular also from more components.

In the embodiment illustrated, only one structure-borne sound sensor 3 is required which, in the embodiment illustrated, is arranged in a manner laterally offset somewhat from the centre, in the vicinity of the circumference of the sliding bearing 1 and on the front side of the sliding bearing apparatus 10. The structure-borne sound produced during operation of the sliding bearing 1 is effectively transmitted through the solid bodies to the structure-borne sound sensor 3. In this case, it is useful to arrange the structure-borne sound sensor 3 in the vicinity of external application of force. A Physical Acoustics WD 100-900 kHz broadband sensor, for example, can be used as the structure-borne sound sensor 3. The structure-borne sound sensor 3 may have a piezo element.

In the embodiment illustrated, a force F_{N} (that is to say a bearing load) is applied from above (see FIG. 4) to the holder 2 of the sliding bearing 1, which holder has a supporting hole 4 for this purpose. An oil supply feed line 5 is situated on the opposite side of the holder 2.

FIG. 4 also illustrates that a shaft 6—mounted in two supporting bearings 7, 8—is guided through the sliding bearing 1. The shaft 6 is driven by an electric motor 9.

It is expected that no modulation occurs in the received signal in the case of the fluid friction during operation of the sliding bearing 1 since there is no rubbing of the shaft 6 and the lining of the sliding bearing 1. Modulation should be able to be seen in the signal in the case of mixed friction events.

A descending speed ramp was run under a constant load F_{N}. Each speed was retained for three seconds. With a constant load F_{N}, it is therefore possible to move from the fluid friction, which occurs at high speeds, to the range of the mixed friction.

FIG. 5 illustrates, by way of example, the structure-borne sound signal S and the Z signal Z from the incremental encoder for a constant load F_{N} of 1500 N and a speed of 340 rpm. Fluid friction takes place in this range; no modulations can be seen in the signal.

The Z signal Z is the signal from the incremental encoder and is output as a square-wave signal once per revolution. Precisely one revolution of the shaft 6 takes place between two square-wave signals.

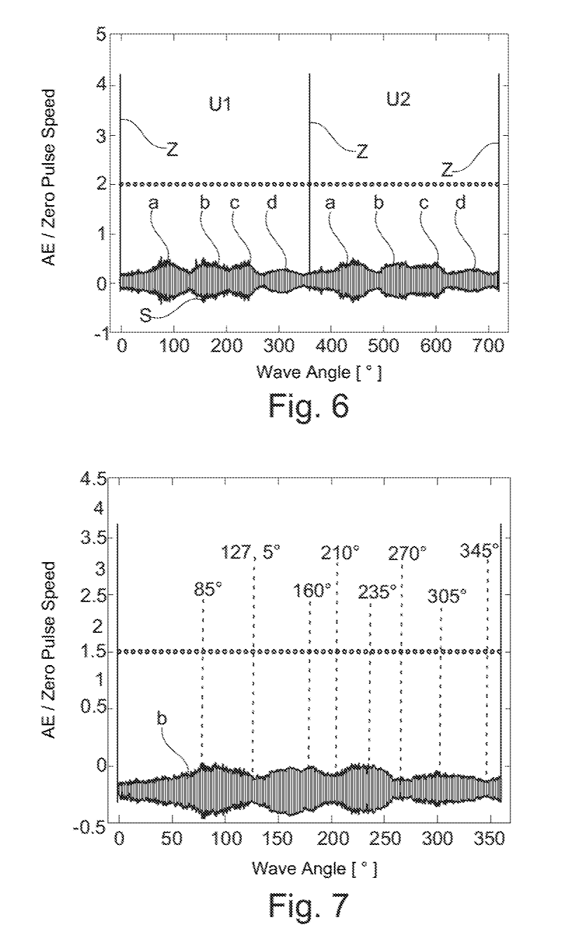

FIG. 6 shows the structure-borne sound signal S and three Z signals likewise for a load F_{N} of 1500 N, but for a speed of 80 rpm. Two complete revolutions U1, U2 are illustrated in FIG. 6.

Mixed friction events a, b, c, d clearly take place between the shaft 6 and the lining of sliding bearing 1. The modulation can be seen in the signal in FIG. 6. Rubbing has respectively taken place at four different points a, b, c, d within one revolution, that is to say mixed friction events a, b, c, d are present.

The maxima and minima in the structure-borne sound signal are indicated for one revolution U1 in FIG. 7 and are assigned to angles on the circumference of the sliding bearing 1. The determination of the maxima and minima was already explained above and is explained in yet more detail in connection with FIG. 9.

This structure-borne sound signal S is then processed using an embodiment of the monitoring method, as described in connection with FIG. 2, for example. This means that the signal is filtered using a high-pass filter and the envelope is then determined by means of averaging (step 202).

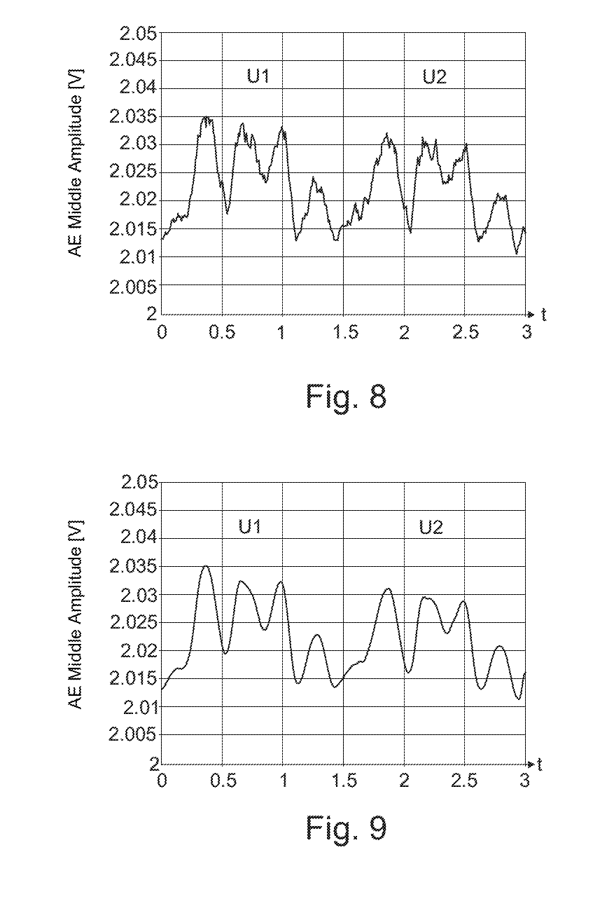

The time is plotted on the x axis in FIGS. 8 and 9.

FIG. 8 illustrates the energy (that is to say on the basis of the RMS) of the envelope of the filtered structure-borne sound signal S for two revolutions U1, U2. The Z signal Z is naturally between the two revolutions U1, U2.

Since the maxima are intended to be numerically determined, the envelope of the structure-borne sound signal S is smoothed using the Savitzky-Golay filter (FIG. 2, step 203).

The signal now produced can be seen in FIG. 9. An angular position on the circumference of the sliding bearing 1 can now be assigned to each maximum (and minimum) by using the zero pulse signal. This has already been depicted in FIG. 7.

It is clear from the descriptions above that a sliding bearing 1 can therefore be efficiently monitored for rubbing (that is to say mixed friction events a, b, c, d) by arranging a structure-borne sound sensor 3 in the vicinity of the sliding bearing 1. A sliding bearing 1 in an engine or an aircraft engine, for example, can therefore be efficiently monitored together with the pulse generator and a computer for evaluating the data.

A possible application for monitoring sliding bearings 1 in an epicyclic planetary transmission 20 is described below.

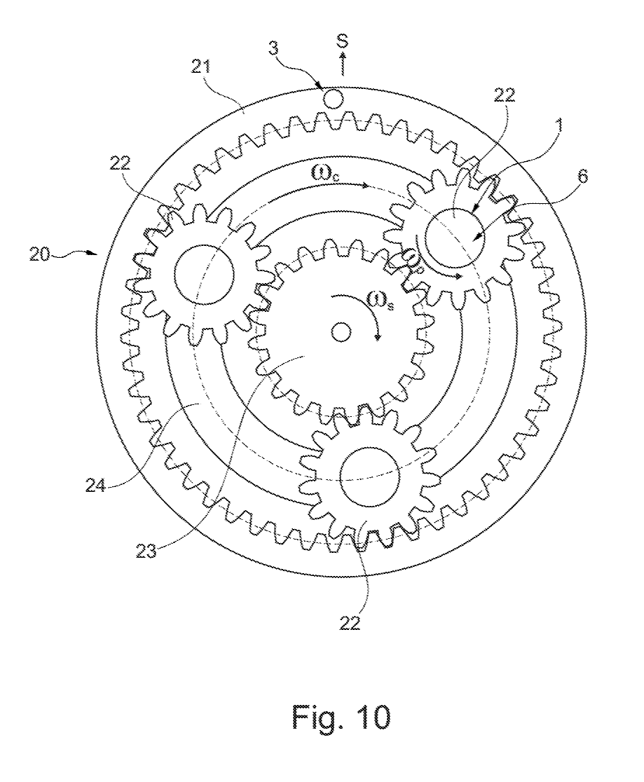

FIG. 10 schematically shows a front view of an epicyclic planetary transmission 20 having a ring gear 21, three planetary gears 22, a sun gear 23 and a carrier 24 (also called planet carrier). Such a planetary transmission 20 can be installed as a reduction transmission in a turbofan engine, for example.

The planetary transmission 20 can be driven via the sun gear 23 which rotates at the angular velocity W. The planetary gears 22 roll on the sun gear 23 and in the ring gear 21 which is assumed to be stationary here. The shafts 6 of the planetary gears 22 are mounted on the carrier 24 by means of sliding bearings 1, with the result that the planetary gears 22 rotate at an angular velocity wₚ. The carrier 24, via which the output of the planetary transmission 20 is effected in the embodiment illustrated, rotates about the axis of the sun gear 23 at the angular velocity W.

In the embodiment according to FIG. 10, a structure-borne sound sensor 3 is installed approximately centrally on the upper edge of the ring gear 21. The structure-borne sound from the sliding bearings 1 is received by said sensor. The data relating to the structure-borne sound signal S can be transmitted from the structure-borne sound sensor 3 to a computer 30 (not illustrated here) via a line or else wirelessly.

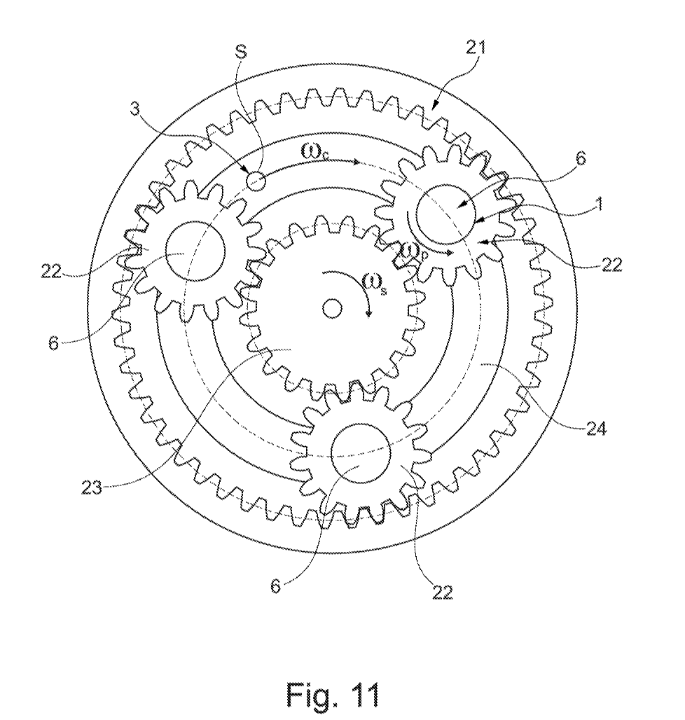

Alternatively, the structure-borne sound sensor 3 can also be arranged on the co-rotating carrier 24, as illustrated in FIG. 11. Here, however, wireless transmission of the structure-borne sound data from the housing of the planetary transmission 20 is useful. Otherwise, the function of monitoring the sliding bearing 1 is the same as in the embodiment according to FIG. 10.

The illustration of the epicyclic planetary transmission 20 should be understood only in an exemplary manner here. In other embodiments, five or more planetary gears may be used, for example. It is also possible for different kinematics to be selected, that is to say the drive and output differ from the example in FIGS. 10 and 11. In particular, it is possible to use other designs for the epicyclic planetary transmission 20 described here. The sliding bearings 1 are monitored in a similar manner.

### LIST OF REFERENCE SIGNS

1 Sliding bearing

2 Sliding bearing holder

3 Structure-borne sound sensor

4 Supporting hole for the application of force

5 Oil supply line

6 Shaft

7 First supporting bearing

8 Second supporting bearing

9 Electric motor

10 Sliding bearing apparatus

20 Planetary transmission

21 Ring gear

22 Planetary gears

23 Sun gear

24 Carrier

30 Computer

a, b, c, d Rubbing points, mixed friction events

F_{N} Applied force

S Structure-borne sound signal

Z Pulse generator signal

1. A method for monitoring a sliding bearing, having a shaft mounted therein, in particular a shaft rotating therein, for at least one mixed friction event, wherein at least one time-dependent structure-borne sound signal from at least one structure-borne sound sensor, in particular precisely one structure-borne sound sensor, is recorded from the sliding bearing, comprising the steps:
a) filtering of the structure-borne sound signal,
b) subsequent calculation of an envelope curve for the filtered structure-borne sound signal,
c) subsequent smoothing of the envelope curve,
d) combination of the data for the smoothed envelope curve with a rotational angle signal which is dependent on the revolution of the shaft in the sliding bearing, wherein the rotational angle signal is determined and/or generated by an incremental encoder by means of pattern recognition or a reference pulse, in particular a magnetic reference pulse, and
e) calculation of at least one maximum, which is correlated with the at least one mixed friction event, from the combined data from step d) for the purpose of determining an angle specification for the at least one mixed friction event on the circumference of the sliding bearing.

2. The method according to claim 1, wherein the rotational angle signal is generated solely by the movement of the shaft and/or of the sliding bearing, in particular by at least one magnetic element of the shaft and/or in the sliding bearing and an accordingly assigned magnetic sensor.

3. The method according to claim 1, wherein the rotational angle signal is actively generated by means of at least one pulse, in particular a zero pulse or a multiplicity of pulses from the incremental encoder.

4. The method according to claim 1, wherein the filtering has a high-pass filter, in particular with a cut-off frequency of between 50 and 300 kHz, in particular between 80 and 150 kHz.

5. The method according to claim 1, wherein the envelope curve is calculated by means of a Hilbert transform or by averaging a predetermined set of filtered structure-borne sound data points.

6. The method according to claim 1, wherein the envelope curve is smoothed by means of a smoothing filter, in particular a Savitzky-Golay filter.

7. The method according to claim 1, wherein a computer captures and stores the time-dependent data relating to the angle specification, the angle location, the intensity and/or the duration of the at least one mixed friction event on the circumference of the sliding bearing, in particular emits a signal, in particular a warning signal or a repair signal, if a predetermined condition occurs.

8. The method according to claim 1, wherein the sliding bearing is arranged in a planetary transmission, in particular a planetary transmission in a wind power plant, a vehicle or an aircraft engine.

9. The method according to claim 8, wherein kinematic movement data and/or structure-borne sound events of the planetary transmission, in particular the movement data and/or structure-borne sound events of the movements of the sun gear, planet holder and/or planetary gears, are filtered out.

10. An apparatus for monitoring a sliding bearing, having a shaft mounted therein, in particular a shaft rotating therein, for at least one mixed friction event, wherein a structure-borne sound signal from at least one structure-borne sound sensor, in particular precisely one structure-borne sound sensor, is recorded from the sliding bearing, comprising
a) a means for at least filtering the structure-borne sound signal,
b) a means for calculating an envelope curve for the filtered structure-borne sound signal,
c) a means for smoothing the envelope curve, and
d) a means for combining the data for the smoothed envelope curve with a rotational angle signal which is dependent on the revolution of the shaft in the sliding bearing, and the rotational angle signal can be determined and/or generated by an incremental encoder by means of pattern recognition or a reference pulse, in particular a magnetic reference pulse,
e) and a means for calculating at least one maximum, which is correlated with the at least one mixed friction event, from the combined data for the purpose of determining an angle specification for the at least one mixed friction event on the circumference of the sliding bearing.

11. The monitoring apparatus according to claim 10, wherein the at least one structure-borne sound sensor is arranged on the end face of a holder of the sliding bearing.

12. The monitoring apparatus according to claim 10, wherein the at least one structure-borne sound sensor has a piezo element for recording the structure-borne sound.

13. The monitoring apparatus according to claim 10, wherein the at least one structure-borne sound sensor is arranged in the immediate vicinity of the circumference of the sliding bearing, in particular in the immediate vicinity of an application of force.
